(19) United States
(12) Patent Application Publication
(10) Pub. No.: US 2026/0141042 A1
(43) Pub. Date: May 21, 2026

(54) DETECTING DEVICE, DETECTING METHOD, AND DETECTING PROGRAM

(71) Applicant: NTT, Inc., Tokyo (JP)

(72) Inventor: Junya HIWATARI, Tokyo (JP)

(73) Assignee: NTT, Inc., Tokyo (JP)

(21) Appl. No.: 19/119,472

(22) PCT Filed: Oct. 11, 2022
(86) PCT No.: PCT/JP2022/037937

§ 371 Date: Apr. 9, 2025

(51) Int. Cl. G06F 21/31; G06N 20/00

(52) U.S. Cl. CPC G06F 21/316; G06N 20/00

(57) ABSTRACT

A detection device (10) learns a machine learning model (typing characteristic model) so as to minimize an abnormality degree of a user himself/herself with respect to typing by machine learning (for example, unsupervised machine learning) using free typing of the user himself/herself. Thereafter, the detection device (10) calculates a typing abnormality degree of a detection target by using the machine learning model after learning, judges that the typing is performed by a person other than the user himself/herself, and detects abnormality when the calculated abnormality degree exceeds a predetermined threshold value.

### TECHNICAL FIELD

The present invention relates to a detection device, a detection method, and a detection program for detecting an illegal operation.

### BACKGROUND ART

Conventionally, in a field of computer security, there has been an increasing demand for an authentication system using biological information. Among them, keystroke authentication focusing on typing characteristics of a user is an authentication system which is well compatible with computer equipment and is also attracting attention from a point that no special device is required. There has been proposed a technique for improving authentication accuracy of the user by combining machine learning in the authentication system using free typing of the user. For example, a technique for improving classification performance of the user by a combination of learning models (CNN and RNN) has been proposed (see NPL 1).

### CITATION LIST

### Non Patent Literature

[NPL 1] Xiaofeng Lu et. al., “Continuous authentication by free-text keystroke based on CNN and RNN”, Computers & Security 96 (2020) 101861

### SUMMARY OF INVENTION

### Technical Problem

However, the above-described technique is only one for classifying users who perform typing, and it is not one for judging whether or not the user is a regular user. Then, a problem of the present invention is to judge whether or not the user is a regular user by using free typing of the user.

### Solution to Problem

In order to solve the above-described problem, the present invention is characterized in that it includes a first acquisition unit that acquires keystroke information of free typing of a user himself/herself, a learning unit that learns a machine learning model so as to minimize an abnormality degree with respect to the keystroke information of free typing of the user himself/herself by machine learning with respect to the keystroke information of free typing of the user himself/herself, a second acquisition unit that acquires keystroke information of typing of a detection target, an abnormality degree calculation unit that calculates a typing abnormality degree indicated by the keystroke information of the detection target by using the learned machine learning model, an abnormality detection unit that judges that the typing of the detection target is performed by a person other than the user himself/herself and detects abnormality when the calculated abnormality degree exceeds a predetermined threshold value, and an output processing unit that outputs a detection result of the abnormality.

According to the present invention, it is possible to judge whether or not the user is a regular user by using the free typing of the user.

### BRIEF DESCRIPTION OF DRAWINGS

FIG. 1 is a diagram showing a configuration example of a detection device.

FIG. 2 is a diagram showing an example of keystroke information.

FIG. 3 is a flowchart showing an example of a learning procedure by the detection device.

FIG. 4 is a flowchart showing an example of an abnormality detection procedure by the detection device.

FIG. 5 is a diagram showing a computer that executes a detection program.

### DESCRIPTION OF EMBODIMENTS

Hereinafter, modes (embodiments) for performing the present invention will be described with reference to the drawings.

The present invention is not limited to the present embodiment.

### [Outline]

First, an outline of a detection device of the present embodiment will be described. The detection device first acquires keystroke information from free typing of a user, and learns a machine learning model so as to reduce an abnormality degree with respect to the keystroke information of the user himself/herself by unsupervised machine learning. The machine learning model learned at this time is defined as a typing characteristic model of the user himself/herself.

Thereafter, the detection device acquires keystroke information of typing of a detection target. Then, the detection device inputs the acquired typing information to the typing characteristic model and calculates the typing abnormality degree. When the calculated abnormality degree exceeds a certain threshold value, the detection device determines that the typing is performed by another person, and performs abnormality detection. Thus, the detection device can detect an illegal operation by a user who is not registered in advance.

### CONFIGURATION EXAMPLE

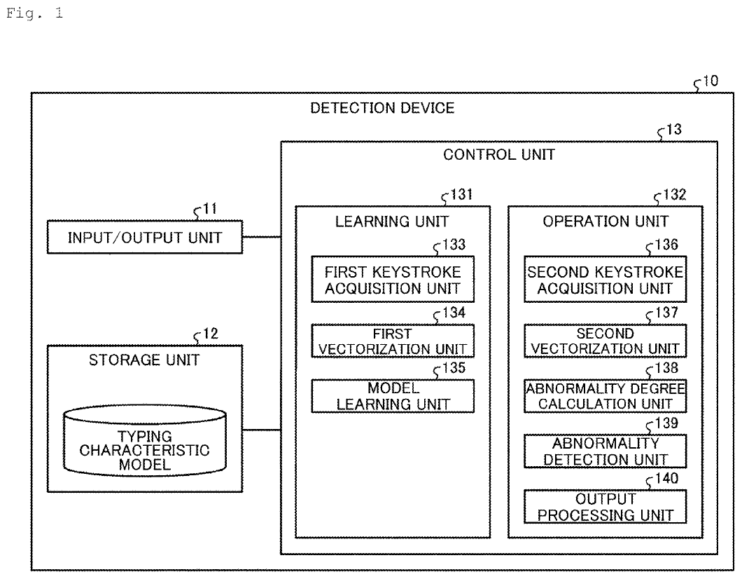

Next, a configuration example of a detection device 10 will be described using FIG. 1. A configuration example of the detection device 10 will be described. The detection device 10 includes an input/output unit 11, a storage unit 12, and a control unit 13, for example.

The input/output unit 11 is an interface that controls input/output of various data. For example, the input/output unit 11 receives input such as typing information of a user himself/herself or typing information of a detection target.

The storage unit 12 stores data referred to by the control unit 13 when executing various types of processing, programs, and the like. The storage unit 12 is realized by a semiconductor memory element such as a RAM (Random Access Memory) or a flash memory or a storage device such as a hard disk or an optical disc.

For example, the storage unit 12 stores parameters of a model (typing characteristic model) indicating the typing characteristics of the user himself/herself learned by the control unit 13. This typing characteristic model is a machine learning model for outputting a degree (abnormality degree) in which the typing characteristic indicated by a series of inputted keystroke information deviates from the typing characteristic of the user himself/herself, for example. The machine learning model is realized by a neural network, for example. The machine learning model is a model using VAE (Variational AutoEncoder), for example.

The control unit 13 controls entire detection device 10. Functions of the control unit 13 are realized by causing a CPU (Central Processing Unit) to execute a program stored in the storage unit 12, for example. The control unit 13 includes a learning unit 131 and an operation unit 132, for example.

The learning unit 131 learns the typing characteristic model of the user himself/herself by the unsupervised learning using free typing of the user himself/herself. For example, the learning unit 131 learns the machine learning model so as to minimize the abnormality degree with respect to the keystroke information of free typing of the user himself/herself by the unsupervised machine learning with respect to the keystroke information of free typing of the user himself/herself.

The learning unit 131 includes a first keystroke acquisition unit 133, a first vectorization unit 134, and a model learning unit 135, for example.

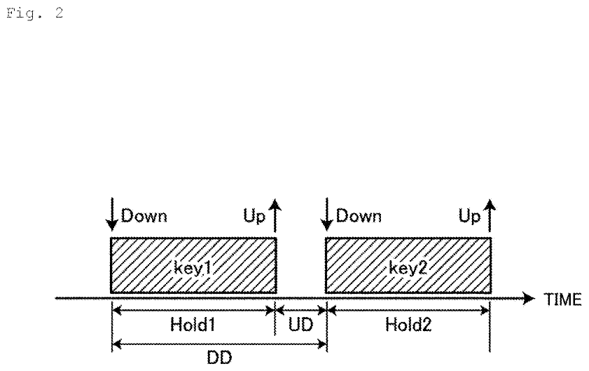

The first keystroke acquisition unit 133 acquires the keystroke information indicating the contents of typing from the free typing of the user himself/herself. The keystroke information is information indicating a key pressed in typing, a time point (Down) when the key is pressed, a time point (Up) when the key is released (see FIG. 2), and the like, for example.

The first vectorization unit 134 vectorizes a series of keystroke information acquired by the first keystroke acquisition unit 133.

For example, as shown in FIG. 2, the first vectorization unit 134 generates a numerical sequence including Down. Up of two adjacent keys (key1·key2), identification information of key1·key2, a time (Hold1, Hold2) to keep key1·key2 pressed, DD (Down to Down), UD (Up to Down), and the like as an element. The first vectorization unit 134 executes the above-described processing on N keys to create N× (information amount) vectors.

The model learning unit 135 performs the machine learning of the typing characteristic model of the user himself/herself by using a plurality of N×(information amount) vectors created by the first vectorization unit 134 as learning data.

In this machine learning, in order to perform the abnormality detection by the keystroke, learning is performed so as to minimize the abnormality degree with respect to the keystroke of the user himself/herself. Note that this machine learning is classified into unsupervised learning, because only the typing data of the person is used, for example. Note that the model learning unit 135 may perform supervised learning in the machine learning of the typing characteristic model by the user himself/herself.

The model learning unit 135 repeats the learning of the typing characteristic model, terminates the learning, and sets the typing characteristic model at that time as the typing characteristic model of the user himself/herself when the abnormality degree does not change.

Note that, by the learning described above, the abnormality degree outputted by the typing characteristic model is minimized for the keystroke of the user himself/herself, and is not minimized for a keystroke of another person.

Therefore, when the keystroke of another person is inputted to the typing characteristic model after learning, a higher abnormality degree is outputted as compared with the case where the keystroke of the user himself/herself is inputted.

Next, the operation unit 132 will be described. The operation unit 132 acquires a series of keystroke information indicating typing of the detection target, and vectorizes the acquired series of keystroke information. Then, the operation unit 132 inputs the vectorized keystroke information to the typing characteristic model of the user himself/herself, and calculates the typing abnormality degree of the detection target. When the abnormality degree exceeds a certain threshold value at that time, the operation unit 132 judges that the typing is performed by another person, and detects the abnormality.

The operation unit 132 includes a second keystroke acquisition unit 136, a second vectorization unit 137, an abnormality degree calculation unit 138, an abnormality detection unit 139, and an output processing unit 140.

The second keystroke acquisition unit 136 acquires a series of keystroke information from typing of the detection target. The second vectorization unit 137 vectorizes the series of keystroke information acquired by the second keystroke acquisition unit 136. For example, when the typing of the detection target occurs in N keys, the second vectorization unit 137 vectorizes a series of keystroke information indicating the typing of the N keys. Since the vectorization method is the same as the vectorization performed by the first vectorization unit 134, the description thereof will be omitted.

The abnormality degree calculation unit 138 calculates the typing abnormality degree of the detection target by using the typing characteristic model of the user himself/herself. For example, the abnormality degree calculation unit 138 inputs the series of keystroke information vectorized by the second vectorization unit 137 to the typing characteristic model of the user himself/herself, and calculates the typing abnormality degree of the detection target.

When the abnormality degree calculated by the abnormality degree calculation unit 138 exceeds the predetermined threshold value, the abnormality detection unit 139 judges that the typing of the detection target is performed by a person other than the user himself/herself, and detects the abnormality. The output processing unit 140 outputs a detection result of abnormality by the abnormality detection unit 139.

### [Example of Processing Procedure]

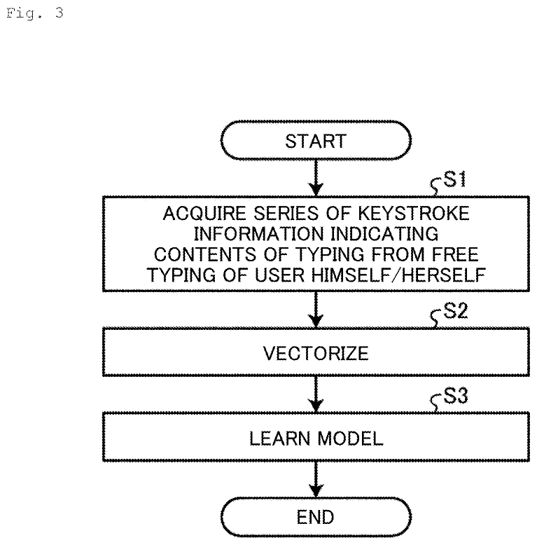

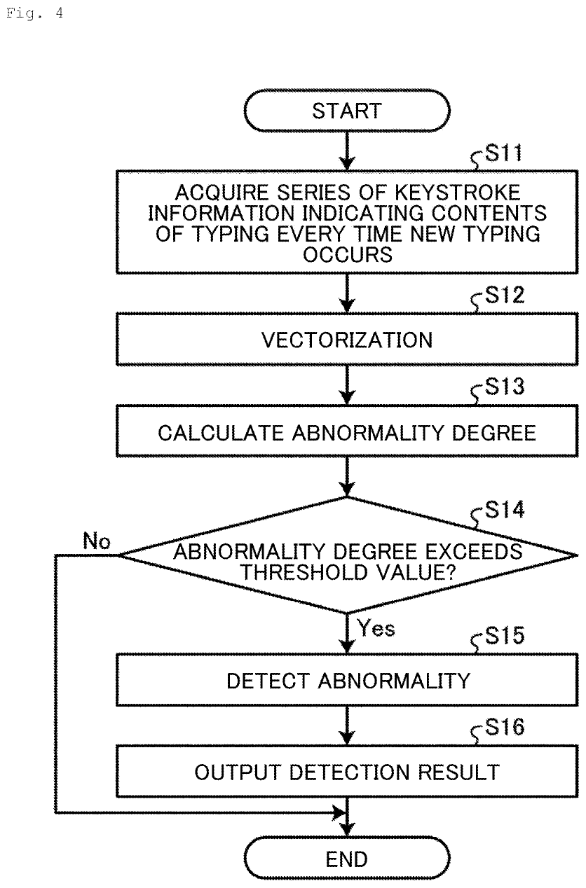

Next, an example of a processing procedure executed by the detection device 10 will be described with reference to FIG. 3 and FIG. 4. First, a learning procedure by the detection device 10 will be described with reference to FIG. 3.

The first keystroke acquisition unit 133 of the detection device 10 acquires a series of keystroke information indicating the contents of typing from the free typing of the user himself/herself (S1). Then, the first vectorization unit 134 vectorizes the series of keystroke information acquired in S1 (S2). Thereafter, the model learning unit 135 learns the typing characteristic model of the user himself/herself by the unsupervised machine learning with respect to the series of keystroke information vectorized in S2 (S3).

Next, an abnormality detection procedure by the detection device 10 will be described with reference to FIG. 4. After learning the typing characteristic model of the user himself/herself, the detection device 10 executes the following processing procedure by the processing procedure shown in FIG. 3, for example.

First, the second keystroke acquisition unit 136 of the detection device 10 acquires a series of keystroke information indicating the contents of typing every time a new typing occurs (S11). Then, the second vectorization unit 137 vectorizes the series of keystroke information acquired in S11 (S12).

Next, the abnormality degree calculation unit 138 inputs the series of keystroke information vectorized in S12 to the typing characteristic model of the user himself/herself, and calculates the typing abnormality degree (S13). Then, when it is judged that the typing abnormality degree calculated in S13 exceeds the predetermined threshold value (Yes in S14), the abnormality detection unit 139 detects the abnormality (S15). Thereafter, the output processing unit 140 outputs a detection result (S16). On the other hand, when it is judged that the abnormality degree calculated in S13 is equal to or less than the predetermined threshold value (No in S14), the abnormality detection unit 139 does not detect the typing abnormality and terminates the processing.

By such a detection device 10, an illegal operation by a user who is not registered in advance can be detected.

### [System Configuration, etc.]

In addition, each configuration component of each unit shown in the drawings is functionally conceptual, and is not necessarily physically configured as shown in the drawings. In other words, specific forms of distribution and integration of each device are not limited to those shown in the drawings and all of or a part of the device may be functionally or physically configured by the distribution or integration in any unit depending on various loads, usage conditions, or the like. Further, all or any part of each processing function performed in each device can be realized by a CPU and a program executed by the CPU, or may be realized as hardware by a wired logic.

In addition, among the steps of processing described above in the embodiment described above, all or some of the steps of processing described as being automatically executed may also be manually executed. Alternatively, all or some of the steps of processing described as being manually executed may also be automatically executed using a known method. In addition, the processing procedure, the control procedure, specific names, information including various types of data and parameters that are shown in the above-described document and drawings may be arbitrarily changed unless otherwise described.

### [Program]

The detection device 10 described above can be implemented by installing a program (detection program) as package software or online software in a desired computer. For example, an information processing device can be caused to function as the detection device 10 by causing the information processing device to execute the above-described program. The information processing device referred to here includes a mobile communication terminal such as a smartphone, a mobile phone, or a PHS (Personal Handyphone System), and further includes a terminal such as a PDA (Personal Digital Assistant), or the like.

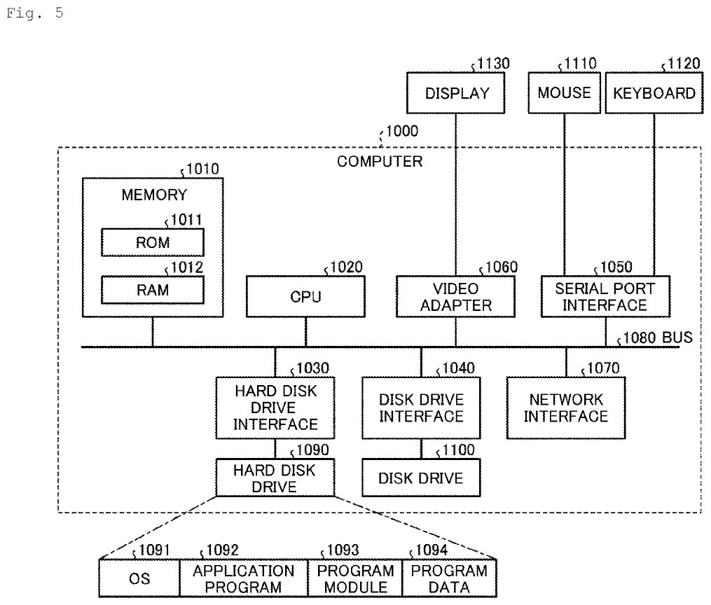

FIG. 5 is a diagram showing one example of a computer that executes the detection program. A computer 1000 includes a memory 1010 and a CPU 1020, for example. In addition, the computer 1000 has a hard disk drive interface 1030, a disk drive interface 1040, a serial port interface 1050, a video adapter 1060, and a network interface 1070. Each unit of these is connected to each other by a bus 1080.

The memory 1010 includes a ROM (Read Only Memory) 1011 and a RAM (Random Access Memory) 1012. The ROM 1011 stores a boot program such as a BIOS (Basic Input Output System), for example. The hard disk drive interface 1030 is connected to a hard disk drive 1090. The disk drive interface 1040 is connected to a disk drive 1100. A removable storage medium such as a magnetic disk or an optical disc is inserted into the disk drive 1100, for example. The serial port interface 1050 is connected to a mouse 1110 and a keyboard 1120, for example. The video adapter 1060 is connected to a display 1130, for example.

The hard disk drive 1090 stores an OS 1091, an application program 1092, a program module 1093, and program data 1094, for example. That is, the program defining each type of processing executed by the above-described detection device 10 is implemented as the program module 1093 in which a code executable by the computer is described. The program module 1093 is stored in the hard disk drive 1090, for example. For example, the program module 1093 for executing the same processing as that of the functional configurations of the detection device 10 is stored in the hard disk drive 1090. Note that the hard disk drive 1090 may be replaced with an SSD (Solid State Drive).

In addition, data used in the processing of the above-described embodiments is stored as the program data 1094 in the memory 1010 or the hard disk drive 1090, for example. Then, the CPU 1020 reads the program module 1093 and the program data 1094 stored in the memory 1010 or the hard disk drive 1090 into the RAM 1012 and executes them as necessary.

Note that the program module 1093 and the program data 1094 are not limited to being stored in the hard disk drive 1090, and may be stored in a detachable storage medium and read by the CPU 1020 via the disk drive 1100, or the like, for example. Alternatively, the program module 1093 and the program data 1094 may be stored in another computer connected via a network (a LAN (Local Area Network), a WAN (Wide Area Network), or the like). Then, the program module 1093 and the program data 1094 may be read by the CPU 1020 from another computer via the network interface 1070.

### REFERENCE SIGNS LIST

| | |
|---|---|
| 10 | Detection device |
| 11 | Input/output unit |
| 12 | Storage unit |
| 13 | Control unit |
| 131 | Learning unit |
| 132 | Operation unit |
| 133 | First keystroke acquisition unit |
| 134 | First vectorization unit |
| 135 | Model learning unit |
| 136 | Second keystroke acquisition unit |
| 137 | Second vectorization unit |
| 138 | Abnormality degree calculation unit |
| 139 | Abnormality detection unit |
| 140 | Output processing unit |

1. A detection device comprising to:
acquire keystroke information of free typing of a user himself/herself;
learn a machine learning model so as to minimize an abnormality degree with respect to the keystroke information of free typing of the user himself/herself by machine learning with respect to the keystroke information of free typing of the user himself/herself;
acquire keystroke information of typing of a detection target;
calculate a typing abnormality degree indicated by the keystroke information of the detection target by using the learned machine learning model;
determine that the typing of the detection target is performed by a person other than the user himself/herself and detect abnormality when the calculated abnormality degree exceeds a predetermined threshold value; and
output a detection result of the abnormality.

2. The detection device according to claim 1, wherein
the machine learning is unsupervised machine learning with respect to the keystroke information of free typing of the user himself/herself.

3. The detection device according to claim 2, wherein
the machine learning model is a model using Variational AutoEncoder (VAE).

4. The detection device according to claim 1, wherein
the keystroke information is information indicating a series of keys pressed in typing, a time point when each of the keys is pressed, and a time point when each of the keys is released.

5. A detection method which is executed by a detection device, the detection method comprising:
acquiring keystroke information of free typing of a user himself/herself;
learning a machine learning model so as to minimize an abnormality degree with respect to the keystroke information of free typing of the user himself/herself by unsupervised machine learning with respect to the keystroke information of free typing of the user himself/herself;
acquiring keystroke information of typing of a detection target;
calculating a typing abnormality degree indicated by the keystroke information of the detection target by using the learned machine learning model;
judging that the typing of the detection target is performed by a person other than the user himself/herself and detecting abnormality when the calculated abnormality degree exceeds a predetermined threshold value; and
outputting a detection result of the abnormality.

6. A computer-readable non-transitory recording medium storing computer-executable program instructions that when executed by a processor cause a computer to execute a detection program comprising:
acquiring keystroke information of free typing of a user himself/herself;
learning a machine learning model so as to minimize an abnormality degree with respect to the keystroke information of free typing of the user himself/herself by unsupervised machine learning with respect to the keystroke information of free typing of the user himself/herself;
acquiring keystroke information of typing of a detection target;
calculating a typing abnormality degree indicated by the keystroke information of the detection target by using the learned machine learning model;
judging that the typing of the detection target is performed by a person other than the user himself/herself and detecting abnormality when the calculated abnormality degree exceeds a predetermined threshold value; and
outputting a detection result of the abnormality.

7. The detection method according to claim 5, wherein
the machine learning is unsupervised machine learning with respect to the keystroke information of free typing of the user himself/herself.

8. The detection method according to claim 7, wherein
the machine learning model is a model using Variational AutoEncoder (VAE).

9. The detection method according to claim 5, wherein
the keystroke information is information indicating a series of keys pressed in typing, a time point when each of the keys is pressed, and a time point when each of the keys is released.

10. The computer-readable non-transitory recording medium according to claim 6 wherein the detection method further comprises:
the machine learning is unsupervised machine learning with respect to the keystroke information of free typing of the user himself/herself.

11. The computer-readable non-transitory recording medium according to claim 10 wherein the detection method further comprises:
the machine learning model is a model using Variational AutoEncoder (VAE).

12. The computer-readable non-transitory recording medium according to claim 6 wherein the detection method further comprises:
the keystroke information is information indicating a series of keys pressed in typing, a time point when each of the keys is pressed, and a time point when each of the keys is released.
